(19) United States
(12) Patent Application Publication
(10) Pub. No.: US 2021/0135586 A1
(43) Pub. Date: May 6, 2021

(54) CONVERTER SYSTEM FOR DATA TRANSMISSION INSIDE CONVERTER AND METHOD THEREFOR

(71) Applicant: SILICON MITUS, INC, Seongnam-si, Gyeonggi-do (KR)

(72) Inventors: Jung Ik HA, Seoul (KR); Geon Hong MIN, Hanam-si (KR); Han Suk SEO, Seoul (KR); Jong Hun KIM, Yongin-si (KR)

(21) Appl. No.: 16/638,792

(22) PCT Filed: Jul. 2, 2018
(86) PCT No.: PCT/KR2018/007484

§ 371 Date: Feb. 13, 2020

(30) Foreign Application Priority Data
Aug. 16, 2017 (KR) 10-2017-0103690

(51) Int. Cl. H02M 3/335; H02M 1/08

(52) U.S. Cl. CPC H02M 3/33592; H02M 2001/0054; H02M 1/08

(57) ABSTRACT

The present invention relates to a method for performing a mutual communication between an input stage and an output stage while performing a power transmission therebetween by using an operation mode conversion of a converter even without a separate communication line. To this end, a converter system according an embodiment of the present invention comprises: a converter for converting and transferring power between an input stage and an output stage; an input stage control unit for controlling the input stage of the converter; and an output stage control unit for controlling the output stage of the converter, wherein the input stage comprises a primary-side switch, an inductor and a capacitor, the input stage control unit may adjust the duty ratio (D) and the switching period (Ts) of the primary-side switch to adjust the number of resonances generated due to the inductor and the capacitor, and the output stage control unit may identify data transmitted by the input stage control unit according to the number of the resonances. According to the present invention, it is possible to communicate between an input stage and an output stage simultaneously with a power transfer therebetween by using an operation mode conversion of a converter without using an additional separate communication line or a wireless interface module.

### TECHNICAL FIELD

This invention relates to a communication method using an operation mode conversion of a converter. More specifically, this invention relates to a converter system for transmitting data in a converter and a method thereof that allow an operation mode of a converter to be changed to enable communication between an input and an output without using an additional separate communication line or a wireless interface module. In particular, this invention relates to enabling data communication in a converter, in which a primary side and a secondary side are separated through an isolation transformer, such as a flyback converter, even without a separate communication line connection between the primary side and the secondary side.

### BACKGROUND ART

Generally, a smart charger is a system capable of simultaneously exchanging power and data between the charger and a mobile communication device.

Such a smart charger has a power converter circuit and a communication circuit separately, and the power converter circuit is responsible for controlling power transmission, and the communication circuit is responsible for communication between an input and an output. A functional block of such a conventional smart charger is well illustrated in FIG. 1.

FIG. 1 is a block diagram of a conventional smart charger system, which is disclosed in US Patent Publication No. U.S. Pat. No. 6,246,211 B1 (registration date: Jun. 12, 2001, title: SMART CHARGER).

Referring to FIG. 1, a communication circuit communicates through a separate communication line or an existing wireless interface module such as an infrared (IR) module, a Bluetooth protocol module, or the like. When the separate communication line is used, a separate pin is required for the communication. When the separate wireless interface module is used, a separate circuit is additionally required to make wireless signals.

In the case of conventional communication using a communication line, since a communication line and a pin are required, the overall size of a system is increased. In addition, in the case of a technique for transmitting information using wireless communication, a separate circuit for adding data signals is additionally required and thus the size and price of a system are increased.

### PRIOR ART DOCUMENT

### Patent Document

US Patent Publication No. U.S. Pat. No. 6,246,211 B1 (registration date: Jun. 12, 2001, title: SMART CHARGER)

### SUMMARY OF INVENTION

### Technical Problem

The present invention is directed to providing a communication method capable of transmitting power between an input stage and an output stage and simultaneously communicating therebetween using an operation mode conversion of a converter without using an additional separate communication line or wireless interface module.

The present invention is also directed to providing a communication method capable of reducing the size and price of a system compared to a conventional system by enabling communication through an operation mode conversion of a converter without adding a communication module supporting wired or wireless communication.

### Solution to Problem

One aspect of the present invention provides a converter system including a converter configured to convert and transmit power between an input stage and an output stage, an input stage controller configured to control the input stage of the converter, and an output stage controller configured to control the output stage of the converter, wherein the input stage includes a primary-side switch, an inductor, and a capacitor, the input stage controller adjusts the number of resonances generated due to the inductor and the capacitor by adjusting a duty ratio (D) and a switching cycle (Tₛ) of the primary-side switch, and the output stage controller identifies data transmitted by the input stage controller according to the number of resonances.

The converter may be a flyback converter and may operate in a discontinuous conduction mode (DCM), the inductor may be an inductance of a transformer, and the capacitor may be a capacitance between a drain and a source of the primary-side switch.

The switching cycle (Tₛ) may be determined by Equation 5 below,

Tₛ=Tₒₙ+T_{off}+(2m+1)π\sqrt{LₘC} [Equation 5]

where Tₒₙ is a turn-on time, T_{off} is a turn-off time, m is a target number of resonances, Lₘ is an inductance of the transformer, and C is a capacitance between the drain and the source of the primary-side switch.

The duty ratio may be determined by Equation 8 below,

$$D = \frac{\begin{matrix}- P ( 1 + \frac{{V}_{out}}{{nV}_{i n}} ) + \\ \sqrt{{{P}^{2} ( 1 + \frac{{V}_{out}}{{nV}_{i n}} )}^{2} + 2 P \frac{{V}_{out}^{2}}{{L}_{m}} ( 2 m + 1 ) π \sqrt{{L}_{m} C}}\end{matrix}}{\frac{{V}_{out}^{2}}{{L}_{m}} ( 2 m + 1 ) π \sqrt{{L}_{m} C}} \qquad [ Equation 8 ]$$

where D is a duty ratio, Vᵢₙ is an input voltage, Vₒᵤₜ is an output voltage, P is an output power, n is a turn ratio of the transformer, m is a target number of resonances, Lₘ is an inductance of the transformer, and C is a capacitance between the drain and the source of the primary-side switch.

The output stage controller may measure the number of resonances by applying a zero-voltage detection method to a secondary-side voltage of the transformer.

The output stage controller may identify data according to a comparison result of the number of resonances and a set threshold value.

The output stage may include a secondary-side switch, the output stage controller may adjust the number of resonances generated due to the inductor and the capacitor by adjusting a turn-on time of the secondary-side switch, and the input stage controller may identify data transmitted by the output stage controller according to the number of resonances.

The converter may be a flyback converter and may operate in a DCM, the inductor may be an inductance of a transformer for insulating between the input stage and the output stage, and the capacitor may be a capacitance between a drain and a source of the primary-side switch.

The output stage controller may adjust the number of resonances due to the inductor and the capacitor by maintaining a turn-on state of the secondary-side switch for a delay time after a secondary-side current becomes zero such that the secondary-side current reaches a negative target current value and then turning the secondary-side switch off.

The target current value may satisfy Equation 9 below,

$$\frac{1}{2} {{L}_{m} ( \frac{{I}_{o}}{n} )}^{2} \leq \frac{1}{2} C ( {V}_{i n}^{2} - {n}^{2} {V}_{out}^{2} ) \qquad [ Equation 9 ]$$

where Lₘ is an inductance of the transformer, C is a capacitance between the drain and the source of the primary-side switch, Iₒ is a target current value, n is a turn ratio of the transformer, Vᵢₙ is an input voltage, and Vₒᵤₜ is an output voltage.

When the target current value satisfies Equation 9 described above, since energy stored in the inductor does not completely discharge the capacitor, a parasitic diode of the primary-side switch may not be turned on, and thus a resonance may be generated due to the inductor and the capacitor.

The delay time may be determined by Equation 10 below,

$${T}_{delay} = \frac{{L}_{m} {I}_{o}}{{n}^{2} {V}_{out}} \leq \frac{{V}_{i n} \sqrt{{L}_{m} C}}{n {V}_{out}} \qquad [ Equation 10 ]$$

where T_{delay} is a delay time, Lₘ is an inductance of the transformer, C is a capacitance between the drain and the source of the primary-side switch, Iₒ is a target current value, n is a turn ratio of the transformer, Vᵢₙ is an input voltage, and Vₒᵤₜ is an output voltage.

Another aspect of the present invention provides a communication method in a converter performed by a converter system for transmitting information between an input stage and an output stage in the converter system in which the input stage and the output stage are insulated by a transformer, the input stage includes a primary-side switch, an inductor, and a capacitor, and the output stage includes a secondary-side switch, the method including, when operating in a mode in which information is transmitted from the input stage to the output stage, increasing an inductor current by turning the primary-side switch on for a turn-on time, decreasing the inductor current by turning the primary-side switch off for a turn-off time, and generating a resonance due to the capacitor and the inductor when the inductor current becomes zero, wherein a duty ratio (D) and a switching cycle (Tₛ) of the primary-side switch are adjusted to adjust the number of resonances, and the output stage identifies data transmitted from the input stage according to the number of resonances.

The method further includes, when operating in a mode in which information is transmitted from the output stage to the input stage, maintaining a turn-on state of a secondary-side switch for a delay time (T_{delay}) after the inductor current becomes zero such that the secondary-side current reaches a negative target current value, and adjusting the number of resonances generated due to the inductor and the capacitor by turning the secondary-side switch off after the delay time, wherein the input stage identifies data transmitted from the output stage by detecting the number of resonances.

The converter may be a flyback converter and may operate in a discontinuous conduction mode (DCM), the inductor may be an inductance of a transformer for insulating between the input stage and the output stage, and the capacitor may be a capacitance between a drain and a source of the primary-side switch.

### Advantageous Effects of Invention

According to the present invention, a communication method is provided that enables transmission of power between an input stage and an output stage and simultaneously enables communication therebetween using an operation mode conversion of a converter without using an additional separate communication line or wireless interface module.

Further, a communication method is provided that can reduce the size and price of a system compared to a conventional system by enabling communication through an operation mode conversion of a converter without adding a communication module supporting wired or wireless communication.

In particular, according to the present invention, data can be transmitted between an input stage and an output stage of a converter without a separate communication line, and thus the present invention is more effective when it is difficult to add a communication line between the input stage and the output stage because the input stage and the output stage are spatially separated as in a wireless power transmission device.

### BRIEF DESCRIPTION OF DRAWINGS

FIG. 1 is a block diagram of a conventional smart charger system.

FIG. 2 is a block diagram of a converter system according to one embodiment of the present invention.

FIG. 3 is a diagram exemplarily illustrating a flyback converter that is applicable to one embodiment of the present invention.

FIG. 4 is a diagram illustrating waveforms of voltage and current for describing a discontinuous conduction mode (DCM) operation.

FIG. 5 is a diagram illustrating waveforms of voltage and current in a mode in which information is transmitted from an input stage to an output stage.

FIG. 6 is a diagram exemplarily illustrating a method of receiving data in the output stage in the mode in which information is transmitted from the input stage to the output stage.

FIG. 7 is a diagram illustrating waveforms of voltage and current in a mode in which information is transmitted from an output stage to an input stage in one embodiment of the present invention.

FIG. 8 is a diagram for describing an operation of a converter in a t1-t2 period in FIG. 7.

FIG. 9 is a diagram for describing an operation of the converter in a t2-t3 period in FIG. 7.

FIG. 10 is a diagram for describing an operation of the converter in a t3-t4 period in FIG. 7.

FIG. 11 is a diagram for describing an operation of the converter in a t4-t5 period in FIG. 7.

FIG. 12 is a diagram exemplarily illustrating a method of receiving data at the input stage in the mode in which information is transmitted from the input stage to the output stage.

FIG. 13 is a diagram exemplarily illustrating an entire system block using a flyback converter as an application example of one embodiment of the present invention.

FIG. 14 is a diagram exemplarily illustrating bi-directional data transmission waveforms in one embodiment of the present invention.

FIG. 15 is a diagram exemplarily illustrating a 1:M multi-input and multi-output system as an application example of one embodiment of the present invention.

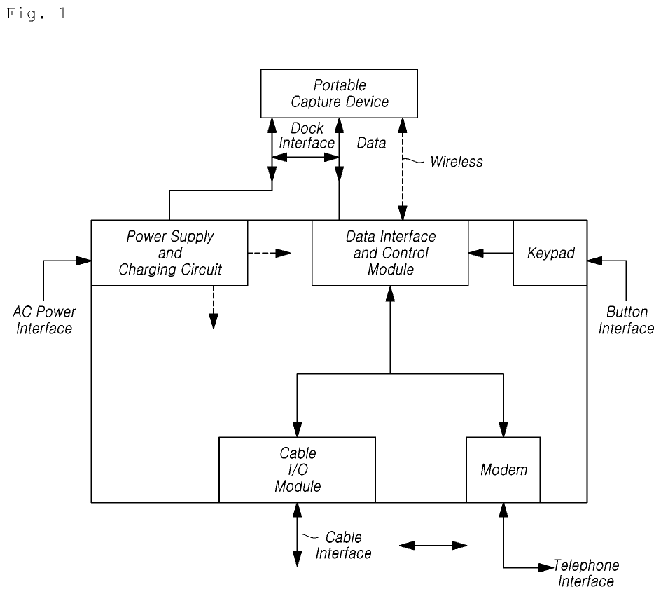

### DETAILED DESCRIPTION OF EMBODIMENT

As specific structural or functional descriptions for the embodiments according to the concept of the present invention disclosed herein are merely exemplified for purposes of describing the embodiments according to the concept of the present invention, the embodiments according to the concept of the present invention may be implemented in various forms but are not limited to the embodiments described herein.

While the embodiments according to the concept of the present invention are susceptible to various modifications and alternative forms, specific embodiments thereof are shown by way of example in the drawings and will herein be described in detail. However, it should be understood that there is no intent to limit the embodiments according to the concept of the present invention to the particular forms disclosed, but on the contrary, the embodiments according to the concept of the present invention are to cover all modifications, equivalents, and alternatives falling within the spirit and scope of the present invention.

While terms such as “first,”, “second,”, or the like may be used to describe various components, such components should not be limited to the above terms. The terms are only used to distinguish one component from another component. For example, a first component could be termed a second component, and, similarly, a second component could be termed a first component without departing from the scope of the present invention.

When it is described that a component is “connected” or “linked” to another component, it should be understood that the component may be directly connected or linked to another component but additional components may be present therebetween. Conversely, when a component is referred to as being “directly connected to” or “directly linked to” another component, there are no intervening components present. Other expressions describing the relationships between components should be interpreted in the same way (e.g., “between” versus “directly between,” “adjacent” versus “directly adjacent,” or the like).

The terms used herein are for the purpose of describing only specific embodiments and are not intended to limit the present invention. As used herein, the singular forms are intended to include the plural forms as well, unless the context clearly indicates otherwise. It should be understood that the terms “comprises,” “comprising,” “includes,” and/or “including” used herein specify the presence of stated features, integers, steps, operations, elements, components, and/or combinations thereof, but do not preclude the presence or addition of one or more other features, integers, steps, operations, elements, components, and/or combinations thereof.

Unless otherwise defined, all terms used herein including technical or scientific terms have the same meanings as those generally understood by those skilled in the art to which the present invention belongs. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

Hereinafter, exemplary embodiments of the present invention will be described in detail with reference to the accompanying drawings.

Descriptions for the operation of a converter system according to one embodiment of the present invention given below may also be applied to descriptions for a communication method in a converter according to one embodiment of the present invention.

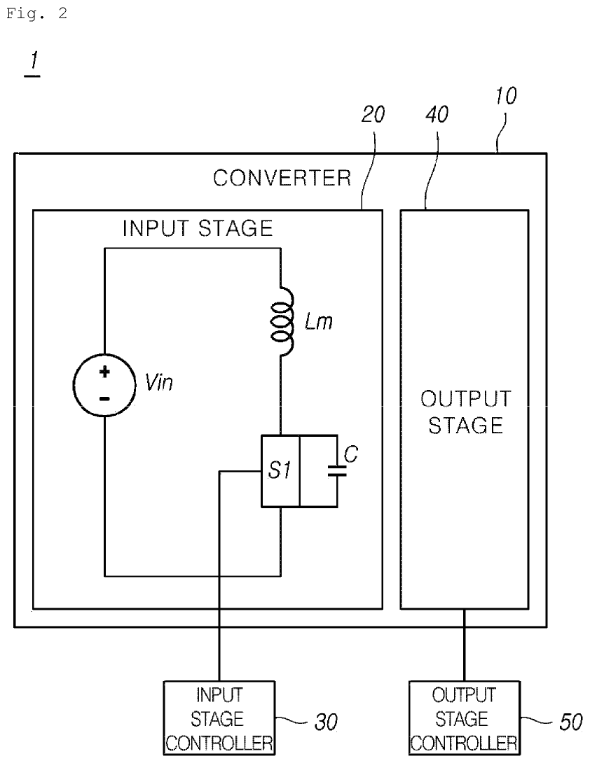

FIG. 2 is a block diagram of a converter system according to one embodiment of the present invention.

Referring to FIG. 2, a converter system 1 according to one embodiment of the present invention may include a converter 10 configured to convert and transmit power between an input stage 20 and an output stage 40, an input stage controller 30 configured to control the input stage 20 of the converter 10, and an output stage controller 50 configured to control the output stage 40 of the converter 10. The converter system 1 is a system capable of transmitting data without a separate communication line between the input stage 20 and the output stage 40 while simultaneously performing a power transmission function therebetween.

The input stage 20 may include a switch, an inductor, a capacitor, and the like and may perform a function of receiving power input from the outside, converting the power, and transmitting the converted power to the output stage.

The input stage controller 30 may control the switch included in the input stage 20 to turn on or off and control the type, magnitude, or the like of the power transmitted to the output stage. Generally, a pulse width modulation (PWM) method is mainly used for adjusting a duty ratio D of the switch, but the present invention is not limited thereto.

In one embodiment of the present invention, in order to transmit data without a separate communication line between the input stage 20 and the output stage 40 while simultaneously transmitting the power therebetween, data transmission between the input stage 20 and the output stage 40 may be performed in such a manner that the input stage controller 30 may adjust the number of resonances generated due to the inductor and the capacitor included in the input stage 20 by adjusting a switching cycle Tₛ and/or duty ratio of the switch included in the input stage 20, and the output stage controller 50 may recognize the information transmitted from the input stage 20 by detecting the number of resonances.

The output stage 40 may include a switch, a diode, and/or the like, receive the power transmitted from the input stage 20, and transmit the power to a load.

The output stage controller 50 may control the switch that may be included in the output stage 40 to turn on or off to control the power received from the input stage 20. In the embodiment of the present invention, in order to transmit data without a separate communication line between the input stage 20 and the output stage 40 while simultaneously transmitting the power therebetween, the output stage controller 50 may detect the number of resonances generated in the input stage 20 (hereinafter, when there is no need to specifically distinguish the input stage 20 from the input stage controller 30, the input stage 20 and the input stage controller 30 are sometimes collectively referred to as the input stage 20, and the same applies to the output stage) and identify the data transmitted from the input stage 20 from the number of detected resonances. To this end, the output stage controller 50 may include a comparator, a pulse counter, and the like. This will be described in detail below.

According to one embodiment of the present invention, data may be transmitted from the output stage 40 to the input stage 20. To this end, the output stage controller 50 may control the switch included in the output stage 40 to turn on or off to adjust the number of resonances generated in the input stage 20, which is described above, and the input stage 20 may recognize data to be transmitted from the output stage 40 by recognizing that the number of resonances intended by the input stage 20 is different from the number of actually generated resonances. The input stage controller 30 may include a comparator, a pulse counter, or the like to detect the number of resonances. This will be described in detail below.

According to the embodiment of the present invention, the converter 10 may include a flyback converter and may operate in a discontinuous conduction mode (DCM), but the present invention is not limited thereto, and various types of converters such as a forward converter, a full-bridge converter, and a half-bridge converter may be used as the converter 10. According to the embodiment of the present invention, resonances may be generated by controlling the switch in the input stage and/or the switch in the output stage in a period after an inductor current becomes zero in the DCM, and the input stage and/or the output stage may detect the number of resonances so that the data may be received from and transmitted to each other.

When a flyback converter is used, an inductance of a transformer configured to electrically insulate between the input stage 20 and the output stage 40 may be used as the inductor for generating the resonance. In addition, the capacitor for generating the resonance may be a capacitance between a drain of and a source of the switch in the input stage. A parasitic capacitance of the switch may be used as the capacitance between the drain and the source of the switch in the input stage, or a separate capacitor may be added to the parasitic capacitance.

In the specification and drawings, it is noted that the same reference numerals are given to a capacitor and the capacitance of the capacitor, and an inductor and the inductance of the inductor.

Hereinafter, one embodiment of the present invention will be described using the case in which the converter 10 is a flyback converter operating in the DCM as an example, but the converter 10 applicable to one embodiment of the present invention is not limited thereto.

<DCM Operation of Flyback Converter>

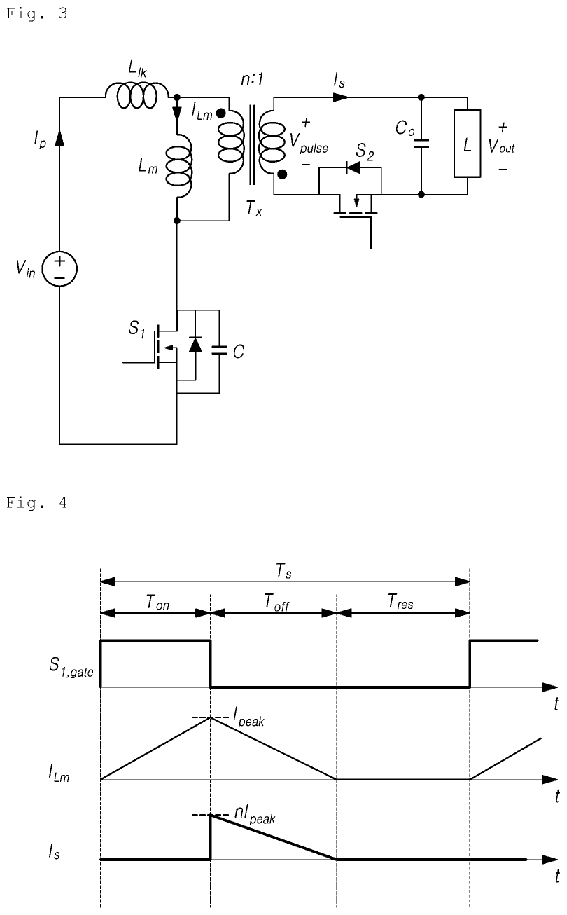

FIG. 3 is a diagram exemplarily illustrating a flyback converter that is applicable to one embodiment of the present invention, and FIG. 4 is a diagram illustrating waveforms of voltage and current for describing a DCM operation. The flyback converter may receive power from an input power source Vᵢₙ, convert the power, and transmit the converted power to a load L. To this end, an input stage of the flyback converter may include a primary-side switch S₁, an inductance Lₗₖ, and an inductance Lₘ, and an output stage may include a secondary-side switch S₂ and an output capacitor Cₒ. A portion of the transformer Tx may be included in each of both the input stage and the output stage, and in this case, a primary-side winding of the transformer Tx may be included in the input stage and a secondary-side winding thereof may be included in the output stage. Although the inductance Lₗₖ and the inductance Lₘ of the input stage may be inductors that are separately added, components inside the transformer may be utilized without adding separate inductors, and in this case, it may be understood that a leakage inductance Lₗₖ and a magnetizing inductance Lₘ by a transformer equivalent circuit are used as the inductors. Hereinafter, the case in which the leakage inductance Lₗₖ and the magnetizing inductance Lₘ of the transformer are used without adding separate inductors will be described as an example.

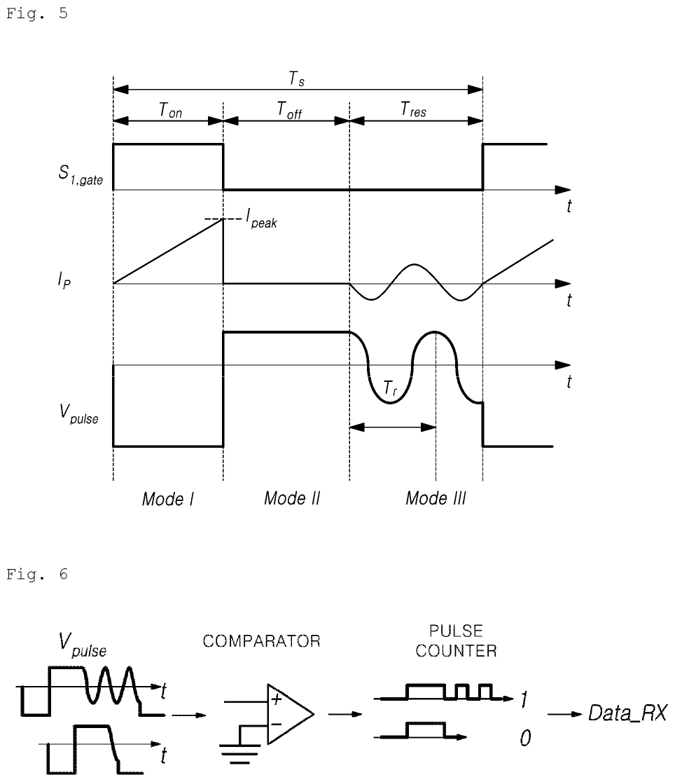

Referring to FIGS. 3 and 4, the flyback converter applied to one embodiment of the present invention operates in the DCM. An inductor current I_{Lm} increases from zero in a Tₒₙ period in which the primary-side switch S₁ is turned on and reaches a peak current Iₚₑₐₖ and decreases in a T_{off} period, in which the primary-side switch S₁ is turned off, to zero. A DCM operation is an operation mode in which the current I_{Lm} flowing through the inductor of the transformer reaches zero as shown in FIG. 4. The flyback converter illustrated in FIG. 3 operates in the DCM when Equation 1 below is satisfied. In FIG. 4, S_{1,gate} is a gate signal for controlling the primary-side switch S₁ to turn on or off, I_{Lm} is the inductor current of the transformer, and Iₛ is a current flowing through the secondary-side winding of the transformer.

$$D < \frac{{nV}_{i n}}{{nV}_{i n} + {V}_{out}} \qquad [ Equation 1 ]$$

where D is a duty ratio of the primary-side switch S₁, Vᵢₙ is an input voltage, Vₒᵤₜ is an output voltage, and n is a turn ratio of the transformer (the turn ratio of the secondary-side winding of the transformer to the primary-side winding of the transformer is defined as n:1 as illustrated in FIG. 3). Power transmitted to an output in the DCM operation may be controlled by adjusting the duty ratio, and assuming that the output voltage is fixed at Vₒᵤₜ, the power transmitted to the output may be calculated as Equation 2 below.

$$P = \frac{{V}_{out}^{2} {D}^{2}}{2 {L}_{m}} {T}_{s} = \frac{{V}_{out}^{2} {T}_{o n}^{2}}{2 {L}_{m} {T}_{s}} \qquad [ Equation 2 ]$$

where P is an output power, Lₘ is an inductance of the magnetizing inductor of the transformer, Tₛ is a switching cycle of the primary-side switch S₁, Tₒₙ is a turn-on time at which the primary-side switch S₁ is turned on, and T_{off} is a turn-off time at which the primary-side switch S₁ is turned off. Tᵣₑₛ is a time at which a resonance may be generated and is a time at which the inductor current I_{Lm} is maintained at zero when the resonance is not generated, but when the resonance is generated according to the embodiment of the present invention, the resonance may be generated in a Tᵣₑₛ period due to the inductor Lₘ and the capacitor C (see FIG. 5). D is the duty ratio of the primary-side switch S₁ and satisfies Tₒₙ=DTₛ. As can be seen from Equation 2, the output power P may be controlled by adjusting values of the duty ratio D and the switching cycle Tₛ. According to the embodiment of the present invention, the duty ratio D and the switching cycle Tₛ may be used to perform the power control and simultaneously perform communication between the input stage and the output stage.

Hereinafter, one embodiment of the present invention will be described by being divided into 1) a case of operating in a mode in which information is transmitted from the input stage to the output stage, and 2) a case of operating in a mode in which information is transmitted from the output stage to the input stage.

<Information Transmission from Input Stage to Output Stage>

FIG. 5 is a diagram illustrating waveforms of voltage and current in a mode in which information is transmitted from the input stage to the output stage in one embodiment of the present invention. In FIG. 5, Iₚ is a current flowing through the leakage inductance Lₗₖ as illustrated in FIG. 3, and Vₚᵤₗₛₑ is a voltage across both ends of the secondary-side winding of the transformer Tx as illustrated in FIG. 3. The output stage controller may identify information transmitted from the input stage by detecting the number of resonances included in Vₚᵤₗₛₑ.

Referring to FIGS. 3 and 5, when one embodiment of the present invention operates in the mode in which information is transmitted from the input stage to the output stage, an operation of increasing the inductor current I_{Lm} by turning the primary-side switch S₁ provided in the input stage of the transformer on for a turn-on time Tₒₙ by the input stage controller, an operation of decreasing the inductor current I_{Lm} by turning the primary-side switch S₁ off for a turn-off time T_{off} by the input stage controller, and an operation of generating resonances due to the capacitor C and the inductor Lₘ when the inductor current I_{Lm} becomes zero may be performed. Here, the capacitor C may be a capacitor C between a drain and a source of the primary-side switch S₁. The input stage controller may adjust the number of resonances by adjusting the duty ratio and the switching cycle Tₛ of the primary-side switch S₁, and the output stage controller 50 may detect the number of resonances and identify data transmitted by the input stage controller according to the number of detected resonances.

This will be described in more detail below.

First, in “Mode I”, the primary-side switch S₁ is turned on for the turn-on time Tₒₙ, and in this period, the inductor current I_{Lm} increases.

Next, in “Mode II”, when the primary-side switch S₁ is turned off, a parasitic diode of the secondary-side switch S₂ is turned on for the turn-off time T_{off} to decrease the inductor current I_{Lm}.

When all of the energy stored in the inductor Lm is discharged at the end point of the Toff period, that is, when the inductor current ILm becomes zero, the parasitic diode of the secondary-side switch S2 is turned off, and a resonance is generated due to the capacitor C between the drain and source of the primary-side switch S1 and inductor Lm of the transformer as shown in “Mode III” in FIG. 5. A resonant frequency thus generated may be expressed as Equation 3 below.

$${f}_{r} = \frac{1}{{t}_{r}} = \frac{1}{2 π \sqrt{{L}_{m} C}} . \qquad [ Equation 3 ]$$

As can be seen from Equation 3, the resonant frequency is a value determined by the inductor Lₘ and the capacitor C, and when the duty ratio D and the switching cycle Tₛ are adjusted, Tᵣₑₛ may be varied and thus the number of resonances generated in the Tᵣₑₛ period may be adjusted. In order to determine the number of resonances on the basis of the secondary-side voltage Vₚᵤₗₛₑ of the transformer Tx becoming zero, a zero-voltage detection circuit may be used, and in this case, when it is assumed that the number of resonances is m, the switching cycle Tₛ needs to satisfy the condition of Equation 4 below.

Tₒₙ+T_{off}+(2m−½)π\sqrt{LₘC}≤Tₛ<Tₒₙ+T_{off}+(2m+3/2)π\sqrt{LₘC} [Equation 4]

where Tₛ is a switching cycle, Tₒₙ is a turn-on time, T_{off} is a turn-off time, m is a target number of resonances, Lₘ is an inductance of the transformer, C is a capacitance between the drain and the source of the primary-side switch, and D is a duty ratio.

Here, it is most efficient to turn on the primary-side switch S₁ at a valley point, at which the secondary-side voltage Vₚᵤₗₛₑ of the transformer Tx is decreased, to reduce switching loss, and thus it is preferable to determine the switching cycle Tₛ through Equations 5 to 7 below.

$$\begin{matrix}{T}_{s} = {T}_{on} + {T}_{off} + ( 2 m + 1 ) π \sqrt{{L}_{m} C} & [ Equation 5 ] \\ {T}_{on} = D {T}_{s} , {T}_{off} = \frac{{V}_{out}}{n {V}_{i n}} D {T}_{s} & [ Equation 6 ] \\ {T}_{s} = \frac{n {V}_{i n} ( 2 m + 1 ) π \sqrt{{L}_{m} C}}{n {V}_{i n} - ( n {V}_{i n} + {V}_{out} ) D} . & [ Equation 7 ]\end{matrix}$$

A duty ratio D for the desired power P obtained by substituting Equation 7 into Equation 2 and m, which is the number of resonances, may be calculated as Equation 8 below, and this duty ratio D is substituted into Equation 7 to calculate the switching cycle Tₛ.

$$D = \frac{\begin{matrix}- P ( 1 + \frac{{V}_{out}}{n {V}_{i n}} ) + \\ \sqrt{{{P}^{2} ( 1 + \frac{{V}_{out}}{n {V}_{i n}} )}^{2} + 2 P \frac{{V}_{out}^{2}}{{L}_{m}} ( 2 m + 1 ) π \sqrt{{L}_{m} C}}\end{matrix}}{\frac{{V}_{out}^{2}}{{L}_{m}} ( 2 m + 1 ) π \sqrt{{L}_{m} C}} . \qquad [ Equation 8 ]$$

When the input stage controller generates resonances in such a manner, the output stage controller may measure the number of resonances by applying a zero-voltage detection method to the secondary-side voltage Vₚᵤₗₛₑ of the transformer and may identify data according to the comparison result of a set threshold value and the number of resonances.

This will be described in more detail below.

The input stage may adjust the number of resonances by adjusting the switching cycle Tₛ and the duty ratio D of the primary-side switch S₁, and the output stage 40 may recognize information transmitted from the input stage 20 by measuring the secondary-side voltage Vₚᵤₗₛₑ of the transformer, that is, the voltage across the transformer in the output stage 40, and detecting the number of resonances using the zero-voltage detection circuit.

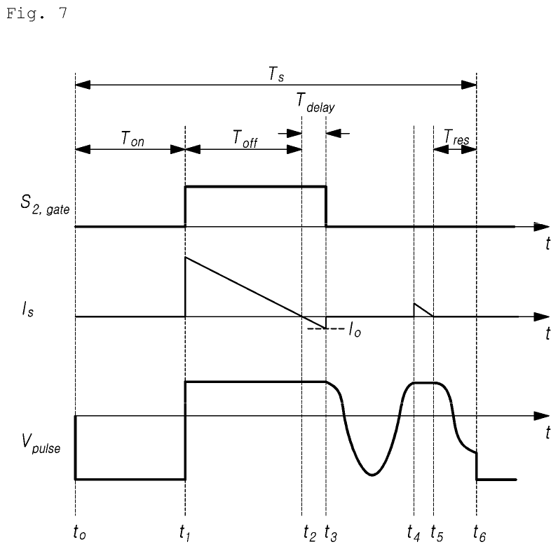

Referring to FIG. 6, in the mode in which information is transmitted from the input stage to the output stage, an example is disclosed in which the output stage controller 50 detects the number of resonances by applying the zero-voltage detection circuit to a waveform of the secondary-side voltage Vₚᵤₗₛₑ of the transformer and extracts data. According to the example disclosed in FIG. 6, the number of resonances may be detected in a manner of inputting the secondary-side voltage Vₚᵤₗₛₑ of the transformer to a comparator so that the comparator outputs pulses corresponding to the number of resonance waveforms and then counting the number of pulses output by the comparator. Information may be transmitted from the input stage to the output stage through a method of determining data as “1” when the number of detected resonances is greater than or equal to a set threshold value and determining data as “0” when the number of detected resonances is less than or equal to the set threshold value.

<Information Transmission from Output Stage to Input Stage>

When operating in the mode in which information is transmitted from the output stage to the input stage, the output stage may include a secondary-side switch S₂, and it may be configured such that the output stage controller adjusts the turn-on time of the secondary-side switch S₂ to adjust the number of resonances generated due to the inductor Lₘ and the capacitor C, and the input stage controller detects the number of resonances and identifies data transmitted by the output stage controller.

This will be described in detail below.

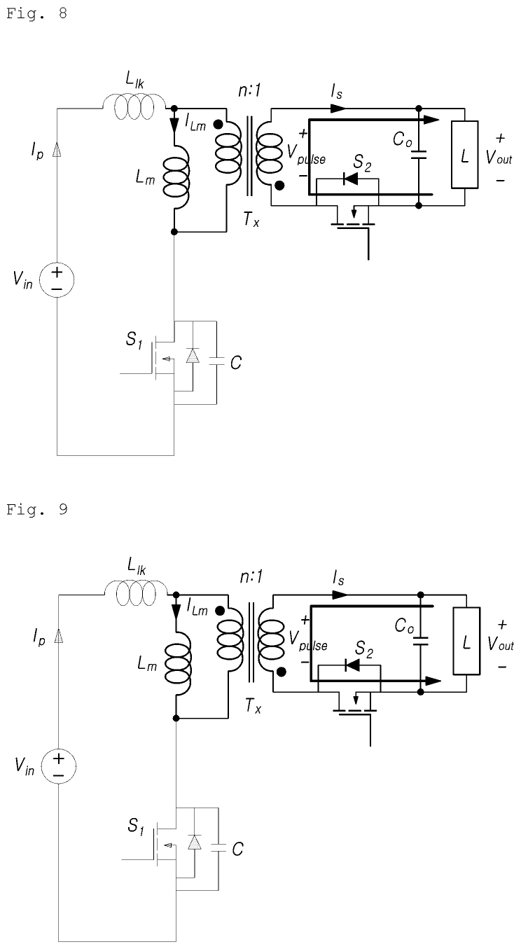

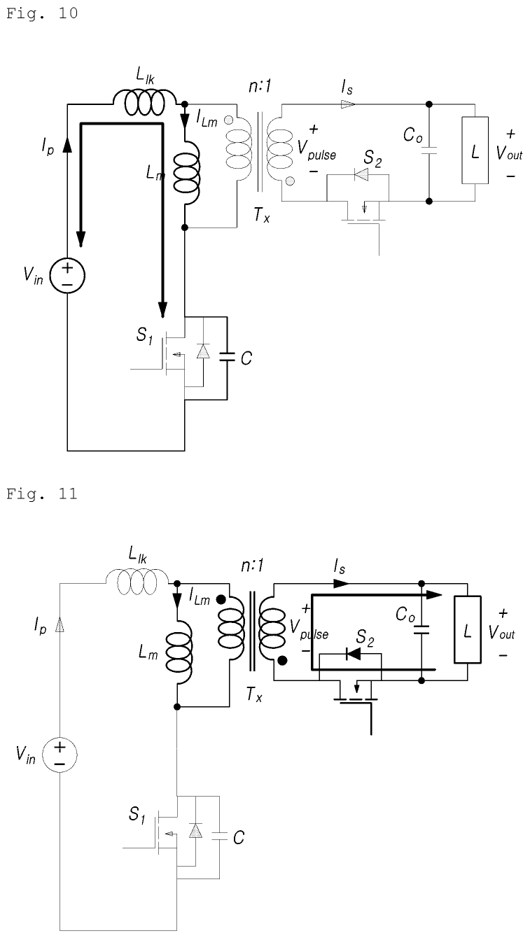

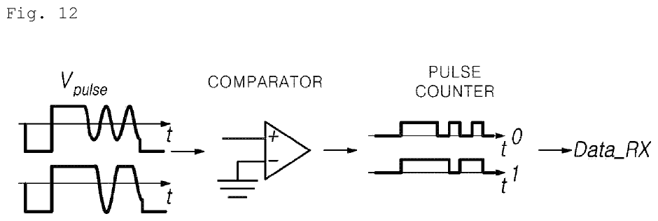

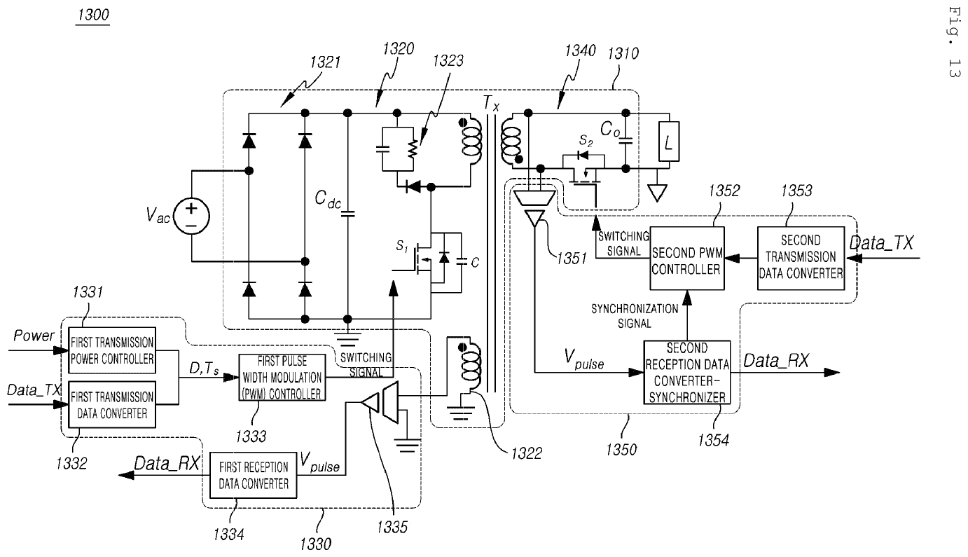

FIG. 7 is a diagram illustrating waveforms of voltage and current in the mode in which information is transmitted from the output stage to the input stage in one embodiment of the present invention, FIG. 8 is a diagram for describing an operation of the converter in a t1-t2 period in FIG. 7, FIG. 9 is a diagram for describing an operation of the converter in a t2-t3 period in FIG. 7, FIG. 10 is a diagram for describing an operation of the converter in a t3-t4 period in FIG. 7, and FIG. 11 is a diagram for describing an operation of the converter in a t4-t5 period in FIG. 7.

In one embodiment of the present invention, the case of operating in the mode in which information is transmitted from the output stage to the input stage will be described with reference to FIG. 3 and FIGS. 7 to 11. In this case, an operation of turning the secondary-side switch S₂ on for the turn-off time T_{off} by the output stage controller when the primary-side switch S₁ is turned off by the input stage controller to decrease the inductor current, an operation of maintaining the turn-on state of the secondary-side switch S₂ during a delay time T_{delay} after the turn-off time Toff by the output stage controller such that a secondary-side current Iₛ of the transformer reaches a negative target current value Iₒ, and an operation of generating resonances due to the inductor Lm of the transformer and the capacitor C of the primary-side switch S₁ by turning the secondary-side switch S₂ off after the delay time T_{delay} by the output stage controller may be performed. The output stage controller may adjust the number of resonances by adjusting the delay time T_{delay} to adjust the negative target current value Iₒ, and the input stage controller may identify data transmitted by the output stage controller according to the number of resonances.

This will be described in more detail below.

When information is transmitted from the output stage to the input stage, the secondary-side switch S2 is used to adjust the number of resonances.

As can be seen from FIGS. 5, 7, and 8, the operation in the period of the turn-on time Tₒₙ and the turn-off time T_{off} is performed in the same manner as the above-described DCM operation.

In a general DCM operation, the secondary-side switch S2 is turned off at the moment when the current flowing through the inductor Lₘ becomes zero. On the other hand, in one embodiment of the present invention, the turn-on state of the secondary-side switch S₂ is maintained until the secondary-side current Iₛ becomes the negative target current value Iₒ. The time from t₂ to t₃ at which the secondary-side current Iₛ has a negative value is the delay time T_{delay}.

In the case in which the primary-side switch S₁ is an ideal switch, when the secondary-side switch S₂ is turned off at t₃, the parasitic diode of the primary-side switch S₁ is turned on due to the current flowing through the inductor Lₘ, thereby transmitting power from the output stage to the input power source Vᵢₙ.

However, in the case of an actual switch, a capacitor exists between the drain and the source, and the parasitic diode of the primary-side switch S₁ is not turned on until the capacitor is completely discharged. In this case, as shown in FIGS. 7 and 10, a resonance is generated between the inductor Lₘ of the transformer and the capacitor C of the primary-side switch S₁. When the magnitude of the negative target current value Iₒ is small and thus the capacitor C is not completely discharged, effective power is not transmitted to the input power source Vᵢₙ, and energy is circulated due to the resonance between the inductor Lₘ of the transformer and the capacitor C of the primary-side switch S₁ so that the effective power is transmitted back to the output stage as shown in FIGS. 7 and 11.

In order for the power to generate a resonance instead of being transmitted from the output stage to the input power source Vᵢₙ as described above, the negative target current value Iₒ needs to satisfy Equation 9 below.

$$\frac{1}{2} {{L}_{m} ( \frac{{I}_{o}}{n} )}^{2} \leq C ( {V}_{i n}^{2} - {n}^{2} {V}_{out}^{2} ) . \qquad [ Equation 9 ]$$

In Equation 9, it is assumed that Vᵢₙ>nVₒᵤₜ is satisfied. When Equation 9 described above is satisfied, energy stored in the inductor Lₘ does not completely discharge the capacitor C of the primary-side switch S₁ and thus the parasitic diode of the primary-side switch S₁ is not turned on. In this case, a primary-side current Iₚ resonates due to the inductor Lₘ and the capacitor C, and no effective power is actually transmitted to the input power source Vᵢₙ. Using Equation 3, the delay time T_{delay} is calculated as shown in Equation 10 below.

$${T}_{delay} = \frac{{L}_{m} {I}_{o}}{{n}^{2} {V}_{out}} \leq \frac{{V}_{i n} \sqrt{{L}_{m} C}}{n {V}_{out}} . \qquad [ Equation 10 ]$$

When the operation is performed as described above, as shown in FIG. 7, the waveform of the secondary-side voltage Vₚᵤₗₛₑ has a flat shape during the time periods of t₂-t₃ and t₄-t₅. Utilizing this, the number of resonances may be reduced through the secondary-side switch S₂ in the output stage, which may be used to transmit information from the output stage to the input stage. That is, the number of resonances may be adjusted by controlling the switching cycle Tₛ and the duty ratio D of the primary-side switch S₁, but when the delay time T_{delay} and the target current value Iₒ are adjusted by the output stage controller through the secondary-side switch S₂, the number of resonances may be changed as intended by the input stage controller through the primary-side switch. In this case, the input stage controller may recognize the information transmitted from the output stage by comparing the number of resonances intended by the input stage controller and the number of actually generated resonances. For example, data may be transmitted from the output stage to the input stage in such a manner that the input stage controller recognizes data as “0” when it is equal to the number of resonances intended by the input stage controller and recognizes data as “1” when the number of actually generated resonances is reduced compared to the number of resonances intended by the input stage controller.

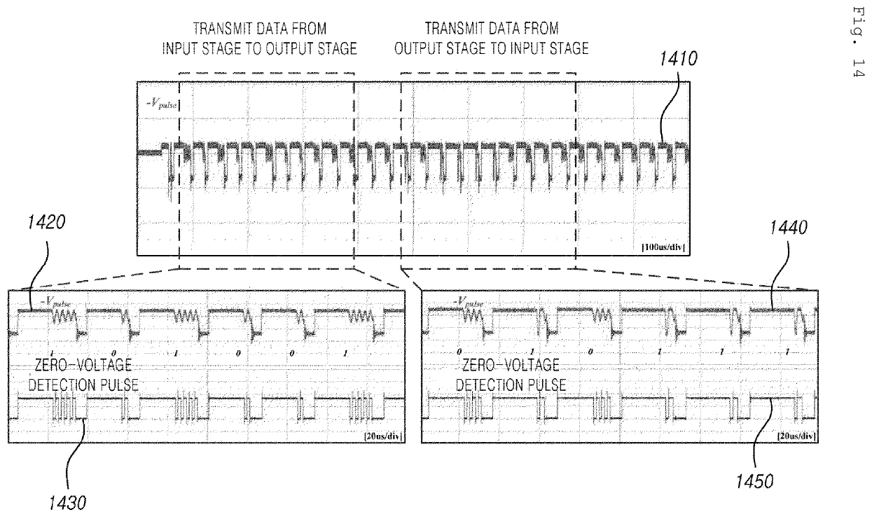

Referring to FIG. 12, in the mode in which information is transmitted from the output stage to the input stage, an example is disclosed in which in order for the input stage to receive data, a primary-side voltage of the transformer corresponding to the waveform of the secondary-side voltage Vₚᵤₗₛₑ of the transformer is measured, and the number of resonances is detected by applying a zero-voltage detection circuit to extract the data. According to the example disclosed in FIG. 12, the number of resonances may be detected in a manner of inputting the primary-side voltage corresponding to the secondary-side voltage Vₚᵤₗₛₑ of the transformer to a comparator so that the comparator outputs pulses corresponding to the number of resonance waveforms and then counting the number of pulses output by the comparator. Communication may be performed by determining data as “0” when there is no change in the number of detected resonances and determining data as “1” when it is confirmed that the number of resonances is reduced. Here, in order for the input stage controller to detect a voltage corresponding to the secondary-side voltage Vₚᵤₗₛₑ of the transformer, as illustrated in FIG. 13, an auxiliary winding 1322 for voltage detection may be added to the transformer Tx, but the present invention is not limited thereto.

FIG. 13 is a diagram exemplarily illustrating an entire system block using a flyback converter as an application example of one embodiment of the present invention.

Referring to FIG. 13, a block diagram of a converter system 1300 according to one embodiment of the present invention employing a communication method using an operation mode conversion of a flyback converter operating in the DCM is disclosed. The converter system 1300 may include a converter 1310, an input stage controller 1330, and an output stage controller 1350, and the converter 1310 may include an input stage 1320 and an output stage 1340.

The input stage 1320 may include a rectifier diode, a direct current (DC) capacitor (C_{dc}), a primary-side switch S₁, a snubber circuit, and an auxiliary winding 1322 for voltage detection and a primary-side winding of a transformer Tx. The rectifier diode may be used to convert input power to DC when the input power is alternating current (AC) and may not be used when the input power is DC. The DC capacitor (C_{dc}) may smooth the input power. The primary-side switch S₁ may be used to control power transmitted from the input stage 1320 to the output stage 1340. The snubber circuit may be used to suppress voltage spikes that may occur during switching of the primary-side switch S₁ and reduce noise, but may not necessarily be included.

The output stage 1340 may include a secondary-side winding of the transformer Tx, a secondary-side switch S₂, and an output capacitor Cₒ and may perform a function of transmitting power transmitted from the input stage 1320 through the transformer Tx to a load L.

The input stage controller 1330 may include a first transmission power controller 1331, a first transmission data converter 1332, a first pulse width modulation (PWM) controller 1333, a first amplifier 1335, and a first reception data converter 1334, but the present invention is not limited thereto, and it will be appreciated that the input stage controller 1330 may further include additional components required for the operation of the converter. The first transmission power controller 1331 may receive information (power) on the power to be transmitted, the first transmission data converter 1332 may receive information (Data_TX) to be transmitted to the output stage 1340, and the first transmission power controller 1331 and the first transmission data converter 1332 may determine a duty ratio D and a switching cycle Tₛ for controlling the primary-side switch S₁ using the information (power) on the power to be transmitted and the information (Data_TX) to be transmitted to the output stage 1340 and send the duty ratio D and the switching cycle Tₛ to the first PWM controller 1333. The first PWM controller 1333 may generate a gate signal of the primary-side switch S₁ using the received duty ratio D and switching cycle Tₛ to control the primary-side switch S₁ to turn on or off.

The first amplifier 1335 of the input stage controller 1330 may receive a voltage, which is a voltage corresponding to Vₚᵤₗₛₑ, detected by the auxiliary winding 1322 for voltage detection of the transformer Tx, amplify the received voltage, and transmit the amplified voltage to the first reception data converter 1334, and the first reception data converter 1334 may detect the number of resonances in the same manner as described above using the voltage detected by the auxiliary winding 1322 for voltage detection to identify data Data_RX transmitted from the output stage 1340. Components for detecting the number of resonances, such as a zero-voltage detection circuit, a comparator, or a pulse counter may be included in the first reception data converter 1334.

The output stage controller 1350 may include a second amplifier 1351, a second PWM controller 1352, a second transmission data converter 1353, a second reception data converter-synchronizer 1354, and the like, and may surely further include other components.

The second transmission data converter 1353 may generate the above-described delay time T_{delay} using the data Data_TX to be transmitted to the input stage 1320 and transmit the delay time T_{delay} to the second PWM controller 1352, and the second PWM controller 1352 may generate a gate signal of the secondary-side switch S₂ using information on the delay time T_{delay} to control the secondary-side switch S₂ to turn on or off.

The second amplifier 1351 may detect the secondary-side voltage Vₚᵤₗₛₑ of the transformer at the secondary-side winding of the transformer Tx and transmit the detected secondary-side voltage Vₚᵤₗₛₑ to the second reception data converter-synchronizer 1354, and the second reception data converter-synchronizer 1354 may identify the data transmitted from the input stage 1320 by detecting the number of resonances from the received secondary-side voltage Vₚᵤₗₛₑ of the transformer and output as the data Data_RX. Components for detecting the number of resonances, such as a zero-voltage detection circuit, a comparator, or a pulse counter may be included in the second reception data converter 1354.

Meanwhile, in order to ensure proper communication between an input and an output, two systems should be synchronized. For example, when a resonance pulse is removed using an input qualification filter under the assumption that a resonant frequency is much greater than a switching frequency, only one pulse per one switching may be obtained and thus may be used as a synchronization signal. A variable such as a delay time T_{delay} required for communication is calculated during initialization, and then the communication is started. In the case of using a communication method according to one embodiment of the present invention, a communication bit rate is varied depending on how many bits are transmitted in one switching, and in the above-described example, the bit rate and the switching frequency may be the same because one bit is transmitted per one switching, but the present invention is not limited thereto, and the bit rate may be greater than the switching frequency when a plurality of bits are transmitted in a manner of dividing a resonance period or the like.

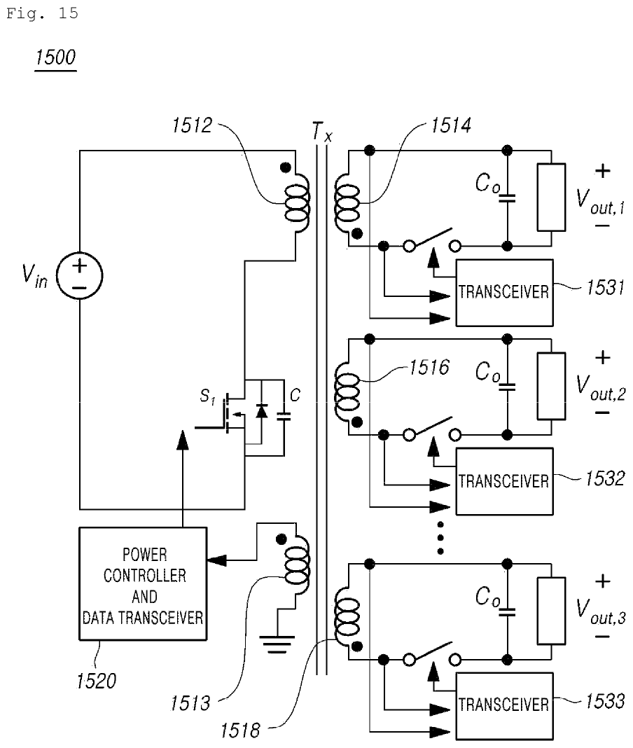

FIG. 14 is a diagram exemplarily illustrating bi-directional data transmission waveforms in one embodiment of the present invention.

In FIG. 14, a reference numeral 1410 illustrates a waveform of the secondary-side voltage Vₚᵤₗₛₑ of the transformer, a reference numeral 1420 is an enlarged waveform of the secondary-side voltage Vₚᵤₗₛₑ of the transformer when data is transmitted from the input stage to the output stage, a reference numeral 1430 illustrates a zero-voltage detection pulse for counting the number of resonances using a zero-voltage detection circuit for the secondary-side voltage Vₚᵤₗₛₑ of the transformer when data is transmitted from the input stage to the output stage, a reference numeral 1440 is an enlarged waveform of the secondary-side voltage Vₚᵤₗₛₑ of the transformer when data is transmitted from the output stage to the input stage, and a reference numeral 1450 illustrates a zero-voltage detection pulse for counting the number of resonances using a zero-voltage detection circuit for the secondary-side voltage Vₚᵤₗₛₑ of the transformer when data is transmitted from the output stage to the input stage. When data is transmitted from the input stage to the output stage, the zero-voltage detection pulse 1430 may be classified into a case of detecting four resonances and a case of detecting one resonance, and thus the output stage may identify information transmitted from the input stage according to the number of detected resonances. When data is transmitted from the output stage to the input stage, the zero-voltage detection pulse 1450 may be classified into a case of detecting three resonances and a case of detecting one resonance, and thus the input stage may identify information transmitted from the output stage according to the number of detected resonances.

That is, when data is transmitted from the input stage to the output stage, the number of resonances may be adjusted through the duty ratio and the switching cycle in the input stage, and when the number of pulses (the number of resonances) obtained through the zero-voltage detection is greater than or equal to a preset threshold value, the output stage may recognize the data as “1”, and otherwise, the output stage may recognize the data as “0”. When data is transmitted from the output stage to the input stage, the output stage may adjust the delay time T_{delay} of the secondary-side switch S₂ to change the number of resonances set by the input stage through the duty ratio and the switching cycle, and the input stage may recognize data transmitted from the output stage by determining whether the number of actually generated resonances is reduced compared to the number of resonances set by the input stage through the duty ratio and the switching cycle.

FIG. 15 is a diagram exemplarily illustrating a 1:M multi-input and multi-output converter system 1500 as an application example of one embodiment of the present invention.

Referring to FIG. 15, in a communication method according to the embodiment of the present invention, data is transmitted using a voltage applied to a transformer Tx, and the above-described manner of communication is possible even in the multi-input and multi-output converter system 1500 in which a plurality of output stages are connected to an input stage through the transformer Tx. However, in the case of the multi-input and multi-output converter system 1500 using one transformer Tx, a plurality of output stages are each magnetically coupled to a primary winding 1512 of the input stage through each of secondary windings 1514, 1516, and 1518, and thus it is difficult for the plurality of output stages to simultaneously transmit data to the input stage. Thus, a communication protocol capable of determining which output stage transmits data to the input stage may be used. Other communication methods may operate similarly to those described above. To this end, the input stage may include a power controller and data transceiver 1520, and the plurality of output stages may use transceivers 1531, 1532, and 1533, respectively, to perform a communication function as described above. Meanwhile, the multi-input and multi-output converter system 1500 illustrated in FIG. 15 is exemplified as including one input stage, but the input stage may also include a plurality of input stages, and the communication method according to the embodiment of the present invention may also be used in a system including a plurality of input stages and a plurality of output stages.

As described in detail above, according to the present invention, it is possible to perform communication between the input stage and the output stage and simultaneously transmit power therebetween using the operation mode conversion of the converter without using an additional separate communication line or wireless interface module.

Further, a communication method is provided that may reduce the size and price of a system compared to a conventional system by enabling communication through the operation mode conversion of the converter without adding a communication module supporting wired or wireless communication.

The communication method according to the embodiment of the present invention may be more effectively used in an application in which it is difficult to add a signal line for data communication because an input stage and an output stage are spatially separated from each other as in wireless power transmission.

### DESCRIPTION OF REFERENCE NUMERALS

1: Converter system
10: Converter
20: Input stage
30: Input stage controller
40: Output stage
50: Output stage controller
S₁: Primary-side switch
S₂: Secondary-side switch
C: Capacitor
Lₘ: Inductor of transformer
I_{Lm}: Inductor current of transformer
Iₚ: Primary-side current
Iₛ: Secondary-side current
Vₚᵤₗₛₑ: Secondary-side voltage of transformer
Vᵢₙ: Input voltage
Vₒᵤₜ: Output voltage

### CROSS-REFERENCE TO RELATED APPLICATION

This application claims priority to and the benefit of Korean Patent Application No. 10-2017-0103690, filed on Aug. 16, 2017, under 35 U.S.C. 119(a), the disclosure of which is incorporated herein by reference in its entirety. In addition, this application claims priority for the same reason for countries other than the United States, all contents of which are incorporated herein by reference.

1. A converter system comprising:
a converter configured to convert and transmit power between an input stage and an output stage;
an input stage controller configured to control the input stage of the converter; and
an output stage controller configured to control the output stage of the converter,
wherein the input stage includes a primary-side switch, an inductor, and a capacitor,
the input stage controller adjusts the number of resonances generated due to the inductor and the capacitor by adjusting a duty ratio (D) and a switching cycle (Tₛ) of the primary-side switch, and
the output stage controller identifies data transmitted by the input stage controller according to the number of resonances.

2. The converter system of claim 1, wherein
the converter is a flyback converter and operates in a discontinuous conduction mode (DCM),
the inductor is an inductance of a transformer, and
the capacitor is a capacitance between a drain and a source of the primary-side switch.

3. The converter system of claim 2, wherein the switching cycle (Tₛ) is determined by Equation 5 below,
Tₛ=Tₒₙ+T_{off}+(2m+1)π\sqrt{LₘC} [Equation 5]
where Tₒₙ is a turn-on time, T_{off} is a turn-off time, m is a target number of resonances, Lₘ is an inductance of the transformer, and C is a capacitance between the drain and the source of the primary-side switch.

4. The converter system of claim 2, wherein the duty ratio is determined by Equation 8 below,
$$D = \frac{\begin{matrix}- P ( 1 + \frac{{V}_{out}}{n {V}_{i n}} ) + \\ \sqrt{{{P}^{2} ( 1 + \frac{{V}_{out}}{n {V}_{i n}} )}^{2} + 2 P \frac{{V}_{out}^{2}}{{L}_{m}} ( 2 m + 1 ) π \sqrt{{L}_{m} C}}\end{matrix}}{\frac{{V}_{out}^{2}}{{L}_{m}} ( 2 m + 1 ) π \sqrt{{L}_{m} C}} \qquad [ Equation 8 ]$$
where D is a duty ratio, Vᵢₙ is an input voltage, Vₒᵤₜ is an output voltage, P is an output power, n is a turn ratio of the transformer, m is a target number of resonances, Lₘ is an inductance of the transformer, and C is a capacitance between the drain and the source of the primary-side switch.

5. The converter system of claim 2, wherein the output stage controller measures the number of resonances by applying a zero-voltage detection method to a secondary-side voltage of the transformer.

6. The converter system of claim 5, wherein the output stage controller identifies data according to a comparison result of the number of resonances and a set threshold value.

7. The converter system of claim 1, wherein
the output stage includes a secondary-side switch,
the output stage controller adjusts the number of resonances generated due to the inductor and the capacitor by adjusting a turn-on time of the secondary-side switch, and
the input stage controller identifies data transmitted by the output stage controller according to the number of resonances.

8. The converter system of claim 7, wherein
the converter is a flyback converter and operates in a DCM,
the inductor is an inductance of a transformer for insulating between the input stage and the output stage, and
the capacitor is a capacitance between a drain and a source of the primary-side switch.

9. The converter system of claim 8, wherein the output stage controller adjusts the number of resonances due to the inductor and the capacitor by maintaining a turn-on state of the secondary-side switch for a delay time after a secondary-side current becomes zero such that the secondary-side current reaches a negative target current value and then turning the secondary-side switch off.

10. The converter system of claim 9, wherein the target current value satisfies Equation 9 below,
$$\frac{1}{2} {{L}_{m} ( \frac{{I}_{o}}{n} )}^{2} \leq \frac{1}{2} C ( {V}_{i n}^{2} - {n}^{2} {V}_{out}^{2} ) \qquad [ Equation 9 ]$$
where Lₘ is an inductance of the transformer, C is a capacitance between the drain and the source of the primary-side switch, Iₒ is a target current value, n is a turn ratio of the transformer, Vᵢₙ is an input voltage, and Vₒᵤₜ is an output voltage.

11. The converter system of claim 10, wherein when the target current value satisfies Equation 9 described above, since energy stored in the inductor does not completely discharge the capacitor, a parasitic diode of the primary-side switch is not turned on, and thus a resonance is generated due to the inductor and the capacitor.

12. The converter system of claim 9, wherein the delay time is determined by Equation 10 below,
$${T}_{delay} = \frac{{L}_{m} {I}_{o}}{{n}^{2} {V}_{out}} \leq \frac{{V}_{i n} \sqrt{{L}_{m} C}}{n {V}_{out}} \qquad [ Equation 10 ]$$
where T_{delay} is a delay time, Lₘ is an inductance of the transformer, C is a capacitance between the drain and the source of the primary-side switch, Iₒ is a target current value, n is a turn ratio of the transformer, Vᵢₙ is an input voltage, and Vₒᵤₜ is an output voltage.

13. A communication method in a converter performed by a converter system for transmitting information between an input stage and an output stage in the converter system in which the input stage and the output stage are insulated by a transformer, the input stage includes a primary-side switch, an inductor, and a capacitor, and the output stage includes a secondary-side switch, the method comprising: when operating in a mode in which information is transmitted from the input stage to the output stage,
increasing an inductor current by turning the primary-side switch on for a turn-on time;
decreasing the inductor current by turning the primary-side switch off for a turn-off time; and
generating a resonance due to the capacitor and the inductor when the inductor current becomes zero,
wherein a duty ratio (D) and a switching cycle (Tₛ) of the primary-side switch are adjusted to adjust the number of resonances, and the output stage identifies data transmitted from the input stage according to the number of resonances.

14. The method of claim 13, further comprising: when operating in a mode in which information is transmitted from the output stage to the input stage,
maintaining a turn-on state of the secondary-side switch for a delay time (T_{delay}) after the inductor current becomes zero such that a secondary-side current reaches a negative target current value; and
adjusting the number of resonances generated due to the inductor and the capacitor by turning the secondary-side switch off after the delay time,
wherein the input stage identifies data transmitted from the output stage by detecting the number of resonances.

15. The method of claim 13, wherein
the converter is a flyback converter and operates in a discontinuous conduction mode (DCM),
the inductor is an inductance of a transformer for insulating between the input stage and the output stage, and
the capacitor is a capacitance between a drain and a source of the primary-side switch.
